(19) United States
(12) Patent Application Publication
(10) Pub. No.: US 2003/0135766 A1
(43) Pub. Date: Jul. 17, 2003

(54) Method and apparatus to control computer system power

(76) Inventors: Paul J. Zyskowski, Chandler, AZ (US); Greg E. Scott, Higley, AZ (US)

Correspondence Address: CHARLES A MIHRO INTEL CORPORATION, BLAKELY SOKOLOFF TAYLOR & ZAFMAN LLP, 12400 WILSHIRE BOULEVARD, 7TH FLOOR, LOS ANGELES, CA, 90025

(21) Appl. No.: 09/453,656

(22) Filed: Dec. 3, 1999

(51) Int. Cl. G06F 1/26

(52) U.S. Cl. 713/300

(57) ABSTRACT

A system includes a power supply adapted to supply power to a device on a peripheral bus at least when the computer system is in a reduced power state. The system also includes a power control circuit adapted to receive a power control signal from the device at least when the computer system is in the reduced power state. The power control circuit transitions the computer system from the reduced power state as a result of receiving the power control signal.

### BACKGROUND

1. Field

The invention relates to controlling the power state of an electronic device, and, more particularly, to controlling the power state of a computer system from a device on a bus.

2. Background Information

As used herein, a computer system is any device comprising a processor to execute instructions and a memory to store the instructions. Computer systems often interface with other devices, called peripheral devices, by way of a bus. As described herein, a bus is one or more conductors for sending and receiving signals between electronic circuits, along with protocols associated with sending and receiving the signals. The bus may be internal or external to the physical casing comprising the circuits and other components of the computer system. An example of an internal bus is the Peripheral Component Interconnect (PCI) bus, as described for example in the PCI Local Bus Specification, Product Version, Revision 2.1, published June 1 1995. An example of an external peripheral bus is the Universal Serial Bus (USB), as described for example in the Universal Serial Bus Specification, Revision 1.0, published January 1996.

In some environments the host device may enter a reduced power state in which the host consumes less power than in a fully-powered state. In this low power state, power consumption by certain components of the computer system may be curtailed in order to reduce overall power consumption. For example, a mass storage device such as a hard drive within the computer system may have power curtailed in the reduced power state, in order to reduce overall system power consumption. When the host enters a low power state, it may also attempt to place devices on internal and external buses into a reduced power state as well. For devices on an external bus, this may involve the host sending the devices a command or request to enter the reduced power state. This command or request may be sent over the external bus. Some implementations may even enable a device on an internal or external bus to send a command or request to the host, in order to place the host in a reduced power consumption state. For example, USB supports such a feature.

The host may have two sources of power for components; a primary power source and a standby power source. Essential components may derive power from the standby power source. Non-essential components, e.g. components to whom power may be discontinued to place the host in a reduced power state, may derive power from the primary power source. Placing the host in a reduced power consumption state may thus involve cutting off the primary power source. The standby power source may remain available while the host is in the reduced power state. Restoring the primary power source may cause the host to enter the fully power state again.

The host may transition from the reduced power consumption state to a fully-powered state (or some power state between the reduced consumption state and the fully-powered state) when an operation is carried out which employs a component to which power has been cut off. For example, power to the hard drive component may be cut off in the reduced consumption state. Power may be restored to the hard drive when the host performs an operation which employs the hard drive, such as reading or writing data to a hard disk. Such restoration of power may be referred to as “waking up” the host. Throughout this document, the term “wake up” may be used interchangeably with the term “transition” to signify the transitioning of the host from a reduced power state to another state in which the host consumes more power than in the reduced power state.

A bus device may be in a reduced power consumption state when it receives a command which it cannot process in the reduced power state. To process the command (or subsequent commands which are expected to follow), the device may “wake up” itself and the host to which it is coupled via the bus. For example, a bus device operating in a reduced power consumption state may receive a “power on” command from a remote control unit (much like a typical television remote control). The power on command may result from a person pressing a power toggle button on the remote control. The device may receive the power on command and transition to a fully-powered state. To process subsequent commands which are expected to follow (for example, channel change commands if the device is a media player), the device may attempt to communicate with the host. However, if the host is operating in a reduced power state it may not be possible for the device to communicate with the host. Such communication may not be possible because, upon entering the reduced power consumption state, the host may have disabled transfer of signals via the bus. The host may need to be woken up before signals may be exchanged between the device and the host over the bus, but the bus cannot be used to wake up the host because it is disabled. There therefore exists a continuing need for a mechanism whereby a bus device may wake up a host from a reduced power consumption state.

### SUMMARY

A system includes a power supply adapted to supply power to a device on a peripheral bus at least when the computer system is in a reduced power state. The system also includes a power control circuit adapted to receive a power control signal from the device at least when the computer system is in the reduced power state. The power control circuit transitions the computer system from the reduced power state as a result of receiving the power control signal.

### BRIEF DESCRIPTION OF THE DRAWINGS

The subject matter regarded as the invention is particularly pointed out and distinctly claimed in the concluding portion of the specification. The invention, however, may be further understood by reference to the following detailed description read with reference to the accompanying drawings.

FIG. 1 shows a block diagram illustrating one embodiment of a system in accordance with the present invention.

FIG. 2 shows a block diagram of an embodiment of a host computer system in accordance with the present invention.

FIG. 3 shows an embodiment of device in accordance with the present invention.

FIG. 4 shows an embodiment of a method in accordance with the present invention.

### DETAILED DESCRIPTION

The embodiments described herein are merely illustrative, and one skilled in the art will appreciate that numerous modifications can be made which nonetheless fall within the scope of the present invention.

In accordance with one embodiment of the present invention, a bus device operates from an independent source of power, or from standby power supplied from the computer system. A power control signal path is established between the device and the computer system to enable to device to wake the computer system from a reduced power state.

FIG. 1 shows a block diagram illustrating one embodiment 100 of a system in accordance with the present invention. Host 104 is coupled to a bus device 106 by way of a bus 108. In one embodiment, host 104 is a computer system which may comprise a personal computer (PC), laptop computer, or handheld computer, among many possibilities. Device 106 may be virtually any electronic device, including mass storage devices (hard drives, compact disk drives, digital video disk drives, etc.) and consumer electronic devices (video cassette recorders, music devices, etc.). In one embodiment, bus 108 is compliant with USB signaling protocols and specifications. USB specifications typically specify four signal paths; a ground GRD, a power path S, and two data paths D1 and D2. The signal path between host 104 and device 106 may also comprise additional components not shown so as not to obscure the present discussion. For example, the signal path may comprise well-known hub and repeater components.

A remote control unit 110 may supply commands via infrared, radio, or other wireless technology to device 106. Of course, commands need not be supplied by remote; button presses or other input techniques to device 106 may also be employed, including automatic and timer-based techniques. Device 106 may derive operating power from power path S from host 104. Unlike conventional USB devices, which may derive power from the primary power source of the host 104, device 106 may derive power from the host's standby power source via power path S. In other words, conventional USB implementations may couple power path S of bus to the host's primary power source. The present invention, however, may couple power path S to the host's standby power source. Thus, even when the host 104 has entered a reduced power state (in which primary power source is cut off), device 106 may derive operating power from the host's standby power source.

Signal path Pon provides a path by which device 106 may signal host 104 to wake host 104 from a reduced power state. On USB, device 106 may detect that the host 104 is in a reduced power state by monitoring the state of one or both of the data paths D1 and D2. When the host 104 is in a full power state, data lines D1 and D2 may be raised to a predefined DC voltage level, for example, 5 volts (systems operating at lower voltages might raise the data paths to 3 volts, 2 volts, or even less). When the host 104 is operating in a reduced power state, the data paths D1 and D2 may be “floating” (an electrical characteristic well known in the art) or grounded, or in some other state wherein the predefined DC voltage level is not present on the paths. The device 106 may detect the power state of host 104 by detecting the presence or absence of the predefined DC voltage level on the data paths D1 and D2.

Device 106 may operate from standby power from power path S even when host 104 is in a reduced power state. Device 106 may receive commands from remote unit 110 and may determine that to process the commands, host 104 should be awakened from a reduced power state. Device 106 may signal host 104 using signal path Pon to wake up the host 104. Once the host 104 is awake, data paths D1 and D2 become usable to communicate with host 104, and device 106 may use the data paths to request that host 104 process the command.

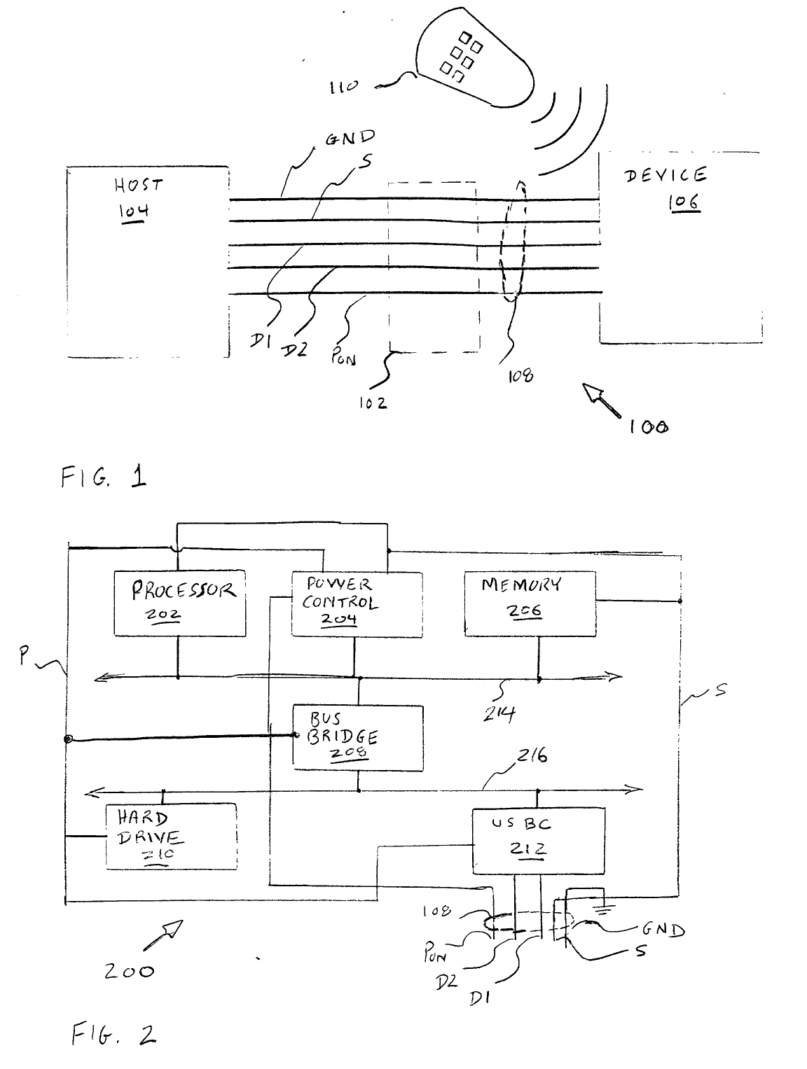

FIG. 2 shows a block diagram of an embodiment 200 of a host computer system in accordance with the present invention. Embodiment 200 comprises a processor 202 to execute instructions supplied from a bus 214. The executed instructions are stored in a memory 206 from which they are supplied to the processor 202 by the memory bus 214 for execution. The processor 202 may be implemented using any semiconductor fabrication technology and may execute any instruction set including, but not limited to, instruction sets supported by an Intel Corporation Pentium® processor or compatible processor. Multiple processors may also be present in the system 200. The memory bus 214 may be implemented using technologies for propagating signals including, but not limited to, electronic and optical conductors and may in fact comprise multiple busses. The memory 206 may include random access memory (RAM), read-only memory (ROM), or any other form of memory capable of storing instructions which may then be supplied to the processor 202 by the memory bus 214 for execution. Of course, the invention is not limited in scope to this particular embodiment. Computer system 200 may of course include other components as well, including a hard drive controller 210 to control access to a machine-readable storage medium, such as a hard disk. The hard disk can store sequences of instructions which may be loaded into memory 206 from which they may be supplied to processor 202 for execution. The machine-readable storage medium may include, but is not limited to, a hard drive, a floppy drive, and a CD-ROM or other optical disk.

To perform signal input/output, computer system 200 may comprise an I/O bus 216 bridged to memory bus 214 by way of a bus bridge circuit 208. I/O bus 216 may be implemented using the same general technologies (electrical, optical, etc.) used to implement memory bus 214. Of course, other peripheral devices may be coupled to I/O bus 216 as well. For example, a keyboard and/or a mouse may each be coupled to the I/O bus 216.

Computer system embodiment 200 further comprises a power control circuit 204. In this embodiment, power control circuit 204 is shown coupled to memory bus 214, although this may not be essential to practice of the present invention. Power control circuit 204 may switch on or cut off primary power on signal path P to other components of the system 200 in response to a command from processor 202. Doing so places the system in a reduced power consumption state. When in such a state, standby power of signal path S is still available to other components of the computer system. For example, hard drive 210 is supplied by primary power path P but not by standby power path S. Processor 202, memory 206, and other “essential” components of the system are supplied by standby power path S. Essential components are those which should receive power even in a reduced power consumption state. When primary power is cut off, hard drive 210 is not supplied with power, but the essential components still receive standby power. Signal path Pon, described in FIG. 1, is coupled to power control 204. When device 106 asserts a power control signal on Pon, power control 204 may restore primary power on signal path P (assuming, or course, that the system is in a reduced power consumption state when the power control signal is received). For example, device 106 coupled to the peripheral bus 108 may send a power control signal over signal path Pon power control circuit 204. This signal may result in power control 204 restoring power on path P. Components which are supplied with power from path P, such as hard drive 210, may thus have power restored.

Computer system 200 further comprises a peripheral bus controller 212 coupled to I/O bus 216. In one embodiment, peripheral bus controller 212 comprises a USB controller (USBC). Peripheral bus 108 comprises signal paths D1, D2, S, and GND, as described in FIG. 1.

FIG. 3 shows an embodiment 300 of device 106 in accordance with the present invention. Embodiment 300 includes an infrared (IR) sensor 306 to sense infrared commands from remote unit 110. Infrared sensor 306 may be coupled to infrared receiver 304. Infrared commands received by sensor 306 may be passed as electrical signals to receiver 304. Receiver in turn may be coupled to controller 302 and may pass electrical command signals to controller 302. Of course, device 106 need not receive commands via infrared. Front panel buttons and radio signals are only a few of the other possible means by which device 106 could receive commands.

Embodiment S may be supplied with power from power path S, coupled to standby power supply of the host 104. Power path S may also be coupled to a power supply which is independent of host power. In either case, power path S supplies power to components of embodiment 300, including controller 302 and receiver 304, even when primary power from host 104 is cut off.

In response to receiving a power command (representing, for example, the press of a power button on remote unit 110), controller 302 may attempt to detect whether host 106 is in a reduced power consumption state. Controller 302 may do so by monitoring the reference DC voltage level on one or both of data paths D2 and D1. Absence of a predetermined DC voltage level on these data paths may indicate that the host 104 is in a reduced power consumption state. Device 106 may then attempt to wake up the host 104 by sending a power control signal on signal path Pon. Power control signal may take the form of raising the voltage level on Pon to a predetermined level, such as 5 volts. Of course, signal may take other forms as well, such as lowering the voltage level on Pon or any combination of raising and lowering the voltage.

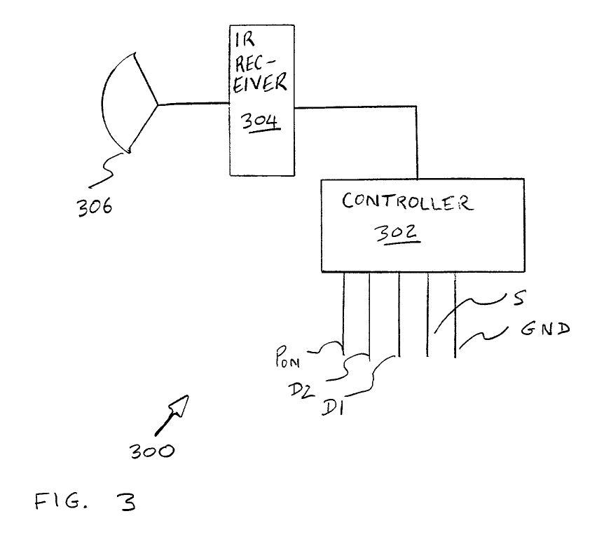

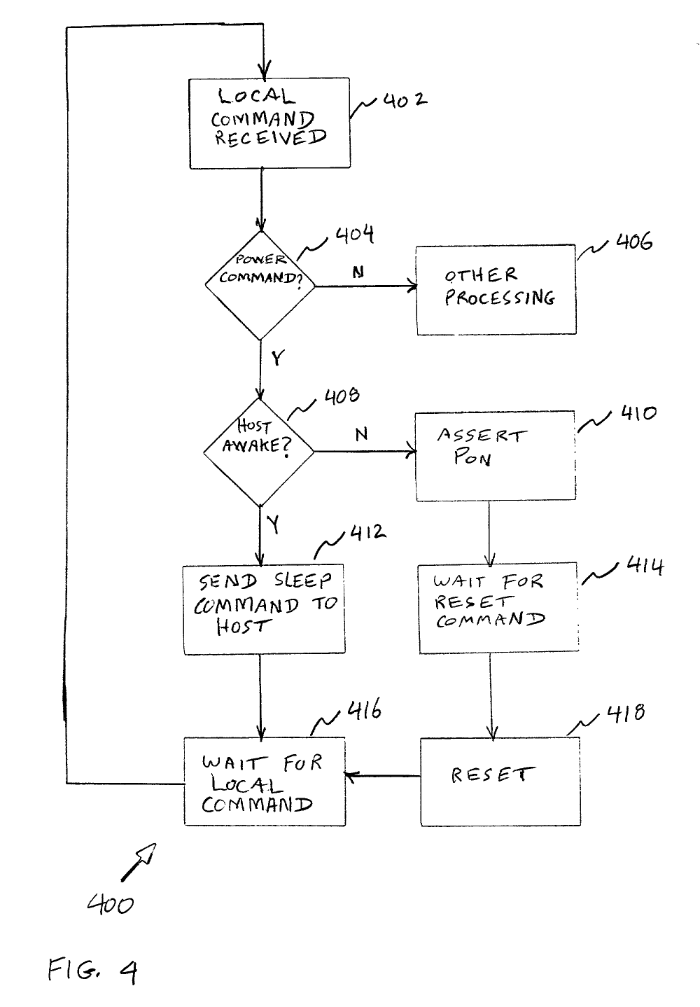

FIG. 4 shows an embodiment 400 of a method in accordance with the present invention. At 402 a “local” command is received by the device 106. Herein the term “local” refers to commands which are not transmitted over the peripheral bus 108, but instead arrive at the device 106 by other means (such as by infrared, front panel button presses, etc.). If at 404 the local command is not a power command, other processing not relevant to a discussion of the present invention may be performed. If at 404 the local command is a power command, a test may be performed at 408 to determine whether the host 104 is awake. As previously described, this test may involve monitoring the voltage level of the bus 108 data signal paths D1 and D2. If the host 104 is not awake, a signal is asserted on path Pon at 410. This signal may result is the host 104 “waking up”, e.g. transitioning from the reduced power consumption state to a state in which more components of the computer system are provided with power. Upon waking up, the host 104 may send a reset command to the device 106. Device 106 may wait for this reset command at 414. Upon receiving reset command, device 106 may perform a self-reset, which may involve initializing various internal electrical states, or the device 106 may ignore the reset command. The device 106 may then wait for a next local command at 416. If, at 408, the host 104 it is determined that the host 104 is awake (in a fully powered state), then the device 106 may send a sleep command to the host 104 by way of the bus 108. In other words, the power command may act as a power toggle for the host 104: if the host 104 is in a reduced power state, the local power command results in the host 104 waking up into a fully powered state; if the host 104 is fully powered, the local power command results in the host 104 entering a reduced power state.

Of course, the method embodiment 400 of FIG. 4 is merely exemplary of possible applications of the present invention. Numerous other applications and embodiments may be employed which nonetheless fall within the scope of the present invention.

While certain features of the invention have been illustrated as described herein, many modifications, substitutions, changes and equivalents will now occur to those skilled in the art. It is, therefore, to be understood that the appended claims are intended to cover all such embodiments and changes as fall within the true spirit of the invention.

What is claimed is:

1. A system comprising:
a power supply adapted to supply power to a device on a peripheral bus at least when the computer system is in a reduced power state; and
a power control circuit adapted to receive a power control signal from the device at least when the computer system is in the reduced power state, the power control circuit to transition the computer system from the reduced power state as a result of receiving the power control signal.

2. The system of claim 1 in which the bus is adapted to support signals which comply with a Universal Serial Bus specification.

3. A system comprising:
a first circuit to supply primary power to a first set of components of the computer system;
a second circuit to provide standby power to a second set of components of the computer system;
a peripheral bus controller to send and receive data from a peripheral bus, the peripheral bus coupled to standby power; and
a power control circuit adapted to supply primary power to the first set of components of the computer system as a result of receiving a power control signal from a device coupled to the peripheral bus.

4. The computer system of claim 3 in which the peripheral bus comprises a data signal path, the power control circuit coupled to a power signal path, the power signal path separate from the data signal path and a power path to the standby power.

5. The computer system of claim 3 in which the peripheral bus is adapted to comply with a Universal Serial Bus specification.

6. A device comprising:
an interface to a computer system to provide power to the device;
a control circuit adapted to provide a signal to the computer system by way of the interface, the signal to transition the computer system from a reduced power state.

7. The device of claim 6 in which the interface is adapted to couple to a standby power source of the computer system.

8. The device of claim 6 in which the device further comprises:
a remote sensor to detect a remote command which results in the signal.

9. A method comprising:
providing power to a device coupled to a peripheral bus of a computer system at least when the computer system is in a reduced power consumption state; and
responsive to a command received from the device, transitioning the computer system from the reduced power consumption state.

10. The method of claim 9 further comprising:
signaling the device in a manner compatible with a Universal Serial Bus specification.

11. A method comprising:
deriving power from a computer system by way of a peripheral bus at least when the computer system is in a reduced power consumption state; and
providing a signal to the computer by way of the peripheral bus which results in the computer system transitioning from the reduced power consumption state.

12. The method of claim 11 further comprising:
providing the signal in response to a remote command.

13. A system comprising:
a computer system; and
a device coupled to the computer system by way of a peripheral bus;
wherein the computer system is adapted to provide power to the device at least while in a reduced power consumption state and to transition from the reduced power consumption state as a result of receiving a signal from the device.

14. The system of claim 13 in which the peripheral bus is adapted to support signals compatible with a Universal Serial Bus specification.

15. The system of claim 13 in which the device is coupled to a standby power source of the computer system.
